(19) United States
(12) Patent Application Publication
(10) Pub. No.: US 2012/0102752 A1
(43) Pub. Date: May 3, 2012

(54) TUBE CUTTER

(76) Inventors: Michael S. Steele, Waukesha, WI (US); Abhijeet A. Khangar, Waukesha, WI (US); Scott R. Fischer, Menomonee Falls, WI (US)

(21) Appl. No.: 13/286,328

(22) Filed: Nov. 1, 2011

Related U.S. Application Data
(60) Provisional application No. 61/408,923, filed on Nov. 1, 2010.

(51) Int. Cl. B23D 21/10; B26D 3/16

(52) U.S. Cl. 30/92

(57) ABSTRACT

A cutting tool includes a first grip portion, a second grip portion, and a first head portion coupled to the first grip portion to define a first handle. The first head portion includes a cutting blade having a cutting portion and a slitting portion. A second head portion is coupled to the second grip portion to define a second handle. The second head portion includes an arcuate portion sized and configured to support the tube and a concave portion sized to receive a portion of the tube. The first handle is pivotally coupled to the second handle to move between an open position and a closed position, wherein the cutting portion is operable to cut the tube as the handles move from the open position and the closed position, and wherein the slitting portion is operable to slice the tube supported in the concave portion when the handles are in the closed position.

### RELATED APPLICATION DATA

This application claims priority to U.S. Provisional Application No. 61/408923 filed Nov. 1, 2010, the contents of which are fully incorporated herein by reference.

### BACKGROUND

The present invention relates to hand operated cutters. More specifically, the present invention relates to hand operated cutters for cutting and splitting tubes.

The use of tubes, including PEX (cross-linked polyethylene) tubes has become popular in plumbing. The tubes are lower cost than copper and are suitable for use in the construction of new buildings and homes.

### SUMMARY

The present invention provides a tube cutter that can be used to cut a tube and to slit a tube along the length of the tube. The cutter is movable between an open position in which it can receive a tube to be cut and a closed position in which a blade passes through the tube to cut the tube. The cutter is movable to a third slitting position in which a portion of the blade extends into a concave tube receiving space defined by a concave surface. The cutter also includes a locking mechanism that is operable to lock the cutter in the closed position.

In one construction, the invention provides a cutting tool adapted to cutting a tube. The cutting tool includes a first grip portion, a second grip portion, and a first head portion coupled to the first grip portion to define a first handle. The first head portion includes a cutting blade having a cutting portion and a slitting portion. A second head portion is coupled to the second grip portion to define a second handle. The second head portion includes an arcuate portion sized and configured to support the tube and a concave portion sized to receive a portion of the tube. The first handle is pivotally coupled to the second handle to move between an open position and a closed position, wherein the cutting portion is operable to cut the tube as the handles move from the open position and the closed position, and wherein the slitting portion is operable to slice the tube supported in the concave portion when the handles are in the closed position.

In another construction, the invention provides a cutting tool adapted to cutting a tube. The cutting tool includes a first grip portion, a second grip portion, and a first head portion coupled to the first grip portion to define a first handle. The first head portion also includes a first channel. A second head portion is coupled to the second grip portion to define a second handle. The second head portion also includes a second channel and a third channel. The first handle is pivotally coupled to the second handle to move between an open position and a closed position. A pin is connected to the first handle and the second handle to define a pivot access about which the first handle and the second handle pivot in a scissors-like motion. A locking pin is movable between a locked position where the locking pin is positioned within the first channel and the second channel and an unlocked position where the locking pin is positioned within the first channel and the third channel.

Other features and aspects of the invention will become apparent by consideration of the following detailed description and accompanying drawings.

### BRIEF DESCRIPTION OF THE DRAWINGS

FIG. 1 is a perspective view of a cutter according to one embodiment of the invention;

FIG. 2 is an enlarged perspective view of a portion of the cutter of FIG. 1;

FIG. 3 is an enlarged perspective view of another portion of the cutter of FIG. 1;

FIG. 4 is partially broken away perspective view of a portion of the cutter of FIG. 1;

FIG. 5 is a section view of a portion of the cutter taken along line 5-5 of FIG. 1;

FIG. 6 is a section view of a portion of the cutter taken along line 6-6 of FIG. 1; and

FIG. 7 is an exploded perspective view of the cutter of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

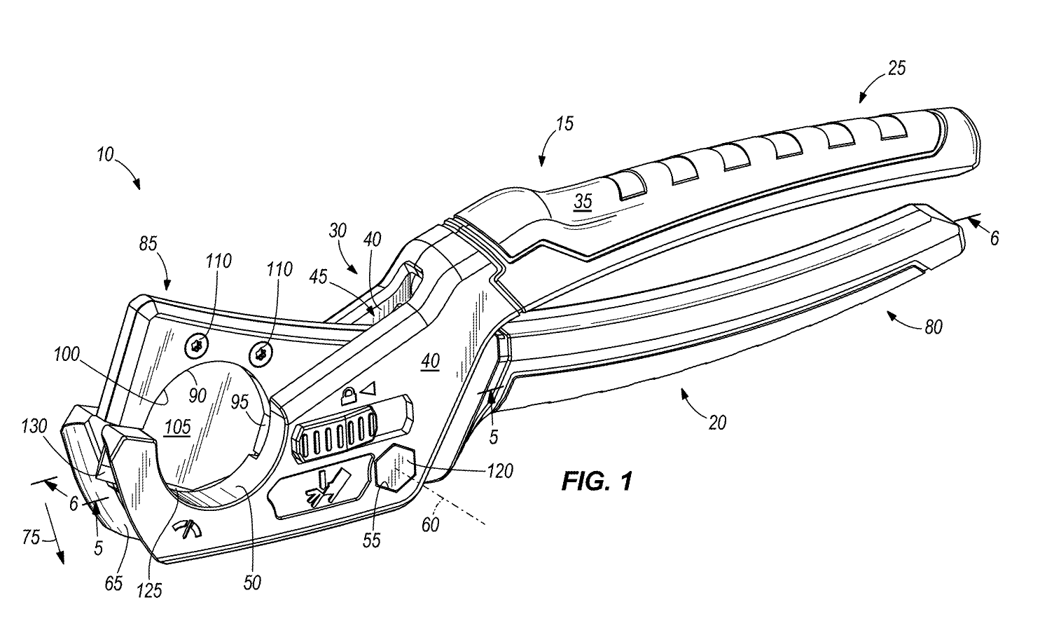

FIG. 1 illustrates a cutter 10 that is well-suited to the task of cutting tubes. In particular the cutter 10 is well-suited to cutting plastic tubes such as PEX (cross-linked polyethylene) tubes. The cutter 10 includes a first handle 15 (sometimes referred to as an outside handle) and a second handle 20 (sometimes referred to as an inside handle).

The first handle 15 includes a first grip portion 25 disposed at one end of the first handle 15 and a first head portion 30 disposed at the opposite end of the first handle 15. The first grip portion 25 is preferably curved to better fit into a user's hand. However, straight portions or different ergonomically-shaped first grip portions 25 could also be employed. In the illustrated construction, a soft grip 35 is positioned over a portion of the first grip portion 25 to improve the grip between the user and the cutter 10. In some constructions, the soft grip 35 is formed as a separate piece and is then positioned on the first grip portion 25. In preferred constructions, the soft grip 35 is over molded or co-molded into position. Of course, other constructions form the soft grip 35 and position the soft grip 35 using other processes and methods.

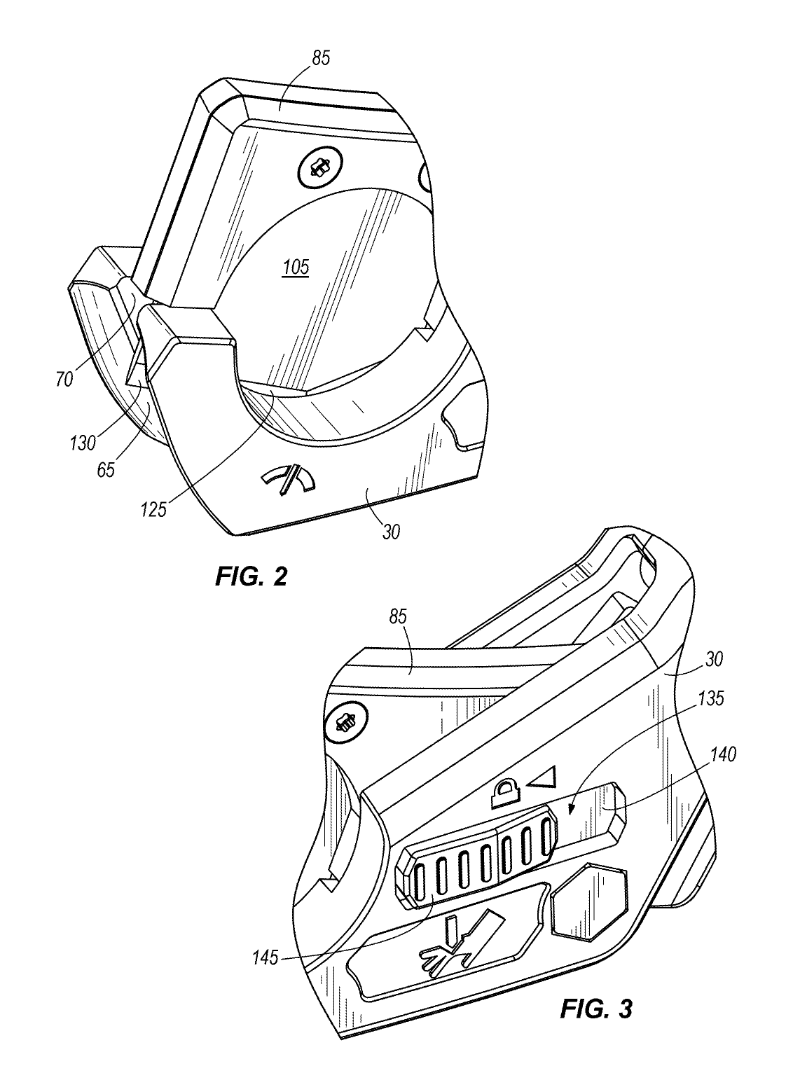

The first head portion 30 includes two spaced apart side portions 40 that cooperate to define a space 45 between the side portions 40. The side portions 40 each include an arcuate aperture 50 that in some constructions is semi-circular. A smaller pivot aperture 55 extends through the first head portion 30 and defines a first pivot axis 60. A first end of the first head portion 30 includes a concave surface 65 that defines a slot 70 or opening (shown in FIG. 2). The slot 70 extends in a slitting direction 75 and the concave surface 65 is preferably arranged such that the slitting direction 75 is parallel to an axis defined by the focus or center of the concave surface 65. Preferably, the slitting direction 75 is also normal to the first pivot axis 60.

In preferred constructions, the first head portion 30 and the first grip portion 25 are formed as a single piece to improve the strength of the first handle 15. Of course, other constructions could form the first head portion 30 separate from the first grip portion 25 and attach them using a suitable attachment means (e.g., welding, soldering, brazing, co-molding, fasteners, adhesives, etc.).

The second handle 20 includes a second grip portion 80 and a second head portion 85. The second grip portion 80 is similar to the first grip portion 25 of the first handle 15 and will not be described in detail. In addition, the second grip portion 80 and the second head portion 85 can be formed as one piece or multiple pieces in much the same way as has been described with regard to the first handle 15 and will not be described in detail.

The second head portion 85 includes a second arcuate aperture 90 that in preferred constructions is semicircular. A slot 95 is formed in a portion of a wall 100 that defines the second arcuate aperture 90 and is sized to receive a portion of a cutting blade 105. In the illustrated construction, the cutting blade 105 fits within the slot 95 and is attached to the second head portion 85 using two fasteners 110. Thus, the cutting blade 105 is easily removable and replaceable. The second head portion 85 also includes a pivot aperture 115 (shown in FIG. 7) that extends along the pivot axis 60.

The second head portion 85 is sized to fit within the space 45 between the first side portion 40 and the second side portion 40 of the first head 30. The first pivot aperture 55 aligns with the second pivot aperture 115. A pin or fastener 120 passes through the pivot apertures 55, 115 to pivotally connect the first handle 15 and the second handle 20. Once connected, the first grip portion 25 and the second grip portion 80 cooperate to define a comfortable and convenient grip for a user.

The cutter 10 of FIG. 1 is movable between a closed or slitting position (shown in FIGS. 1 and 2) and an open position. In preferred constructions, a biasing member 121 (shown in FIG. 7) is positioned to bias the first handle 15 and the second handle 20 toward the open position. Suitable biasing members 121 could include springs (e.g., coil, leaf, torsional, etc.) or other biasing members that function to move the handles 15, 20 toward the open position.

In the open position, the first grip portion 25 and the second grip portion 80 are separated, thereby separating the first head portion 30 and the second head portion 85. In this position, the arcuate apertures 50, 90 are spaced apart from one another a distance sufficient for the positioning of a tube within the arcuate apertures 50, 90. The tube can rest against the aperture walls formed in the first side portion 40 and the second side portion 40. As the cutter 10 (or handles 15, 20) moves toward the closed position, a bottom cutting edge 125 of the blade 105 contacts the tube and begins cutting the tube. In the closed position, the blade 105 has moved through the tube and the cutting edge 125 of the blade 105 is disposed beneath the arcuate apertures 50 of the first head portion 30 and in the space 45 between the first side portion 40 and the second side portion 40. In the illustrated construction, the cutting edge 125 includes a first corner, a second corner, and a point in the middle and is therefore substantially V-shaped. However, other constructions could use straight cutting edges that are normal to the tube or angled with respect to the tube, curved blades, or other suitable shapes.

If the user further squeezes the first grip portion 25 and the second grip portion 80, the cutter 10 will move toward the closed or slitting position as illustrated in FIG. 2. In the slitting position, a slitting portion 130 of the cutting edge 125 of the blade 105 extends through the slot 70 defined in the concave surface 65 of the first head portion 30. In this position, the cutter 10 can be positioned against a tube to slit the tube in a lengthwise direction. The concave surface 65 engages the outer surface of the tube being slit to improve the contact between the tube and the cutter 10. In the illustrated construction, the slitting portion 130 is at least partially defined by the first corner of the cutting edge 125.

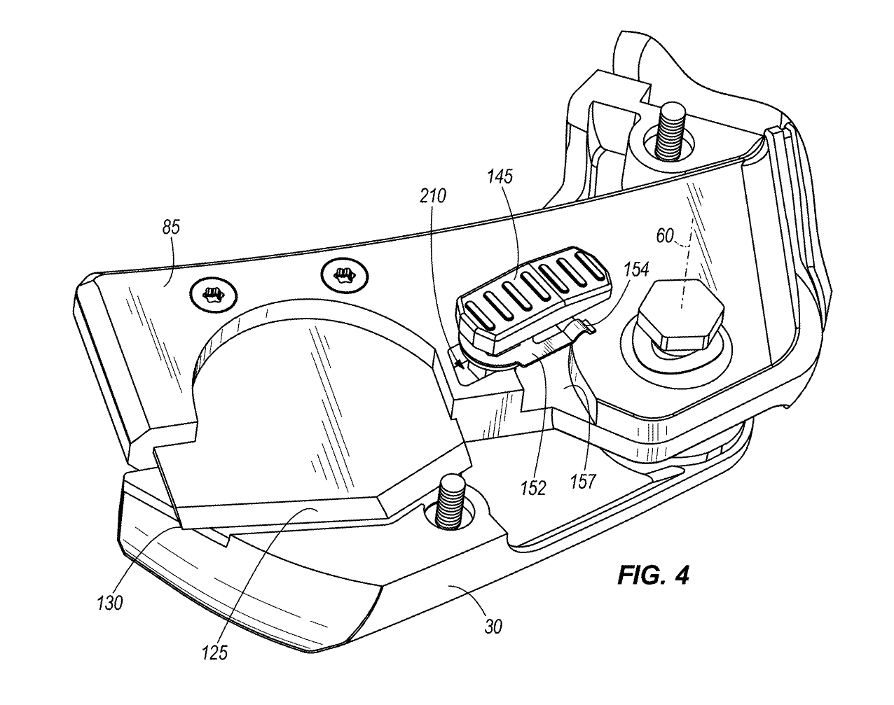

FIGS. 3-4 illustrate a locking mechanism 135 that is suited to locking the first handle 15 and the second handle 20 in the slitting position. As illustrated in FIG. 3, the first head portion 30 includes an external channel 140 that receives a slider 145. The channel is substantially rectangular and extends in a substantially linear direction. The slider 145 is movable between a locked position in which the first handle 15 and the second handle 20 are inhibited from moving with respect to one another and an unlocked position in which the first handle 15 and the second handle 20 are substantially free to pivot about the pivot axis 60.

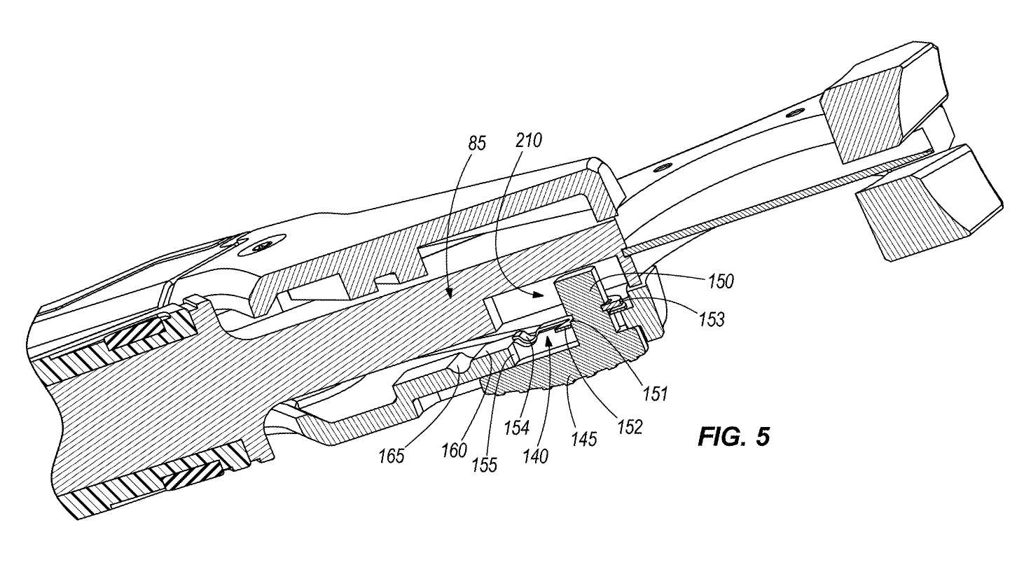

As illustrated in FIGS. 4 and 5, the slider 145 includes a pin 150 that extends through the external channel 140 and into the second head portion 85. The pin 150 has a groove 151 that runs around an outer perimeter of the pin 150. A spring plate 152 is disposed, and preferably fixedly attached to the pin 150, and is secured to the pin 150 by an e-clip 153. The spring plate 152 includes two legs that extend from the pin 150 (when the spring plate 152 is attached to the pin 150) in a cantilever fashion and define two protrusions 154. In the illustrated construction, the pin 150 is cuboidal, with other shapes being possible.

As best seen in FIG. 5, when the slider 145 is in the locked position (i.e., when the slider is pushed toward the blade 105 in the illustrated construction) the protrusions 154 contact a wall 155, the wall 155 defining a side of the external channel 140. The interference between the wall 155 and the protrusions 154 serves to inhibit the slider 145 from leaving the locked position while still allowing the pin 150 and protrusions 154 to move within the channel 140. The user may move the slider 145 out of the locked position by applying a force to the slider 145 (in a direction away from the blade 105), thus forcing the protrusions 154 to move along the wall 155 and onto an internal surface 160 of the first head portion 30. After moving along the internal surface 160, the protrusions 154 will engage an indentation 165 formed in the first head portion 30 that cooperates with the protrusions 154 to bias the slider 145 into the unlocked position and inhibit movement out of that position. Thus, the spring plate 152, and more specifically the protrusions 154 cooperates with the first head portion 30 to bias the pin 150 into one of the locked position and the unlocked position

The slider 145 serves to place the cutter 10 in the locked position or the unlocked position. In the unlocked position the first handle 15 and second handle 20 are biased away from each other by the biasing member 121, however, the biasing member 121 is sized and configured so that the user may overcome the biasing force so that the cutter 10 may be operated in a scissors motion.

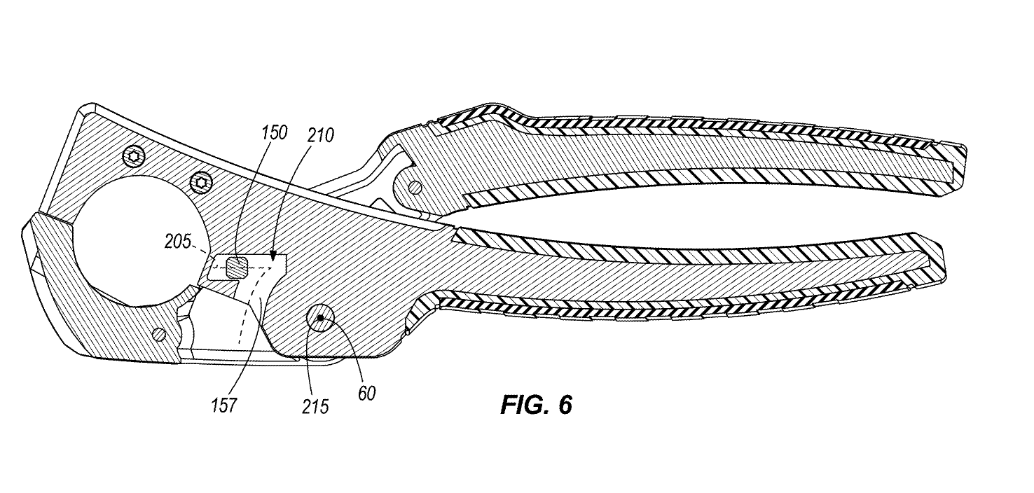

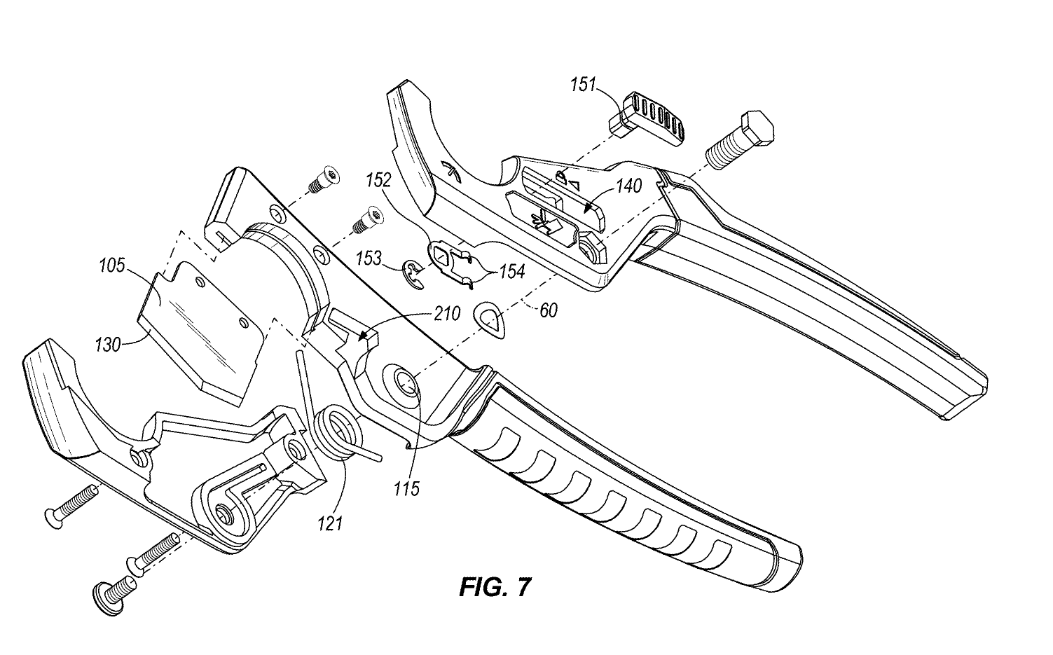

As best seen in FIG. 6, the second head portion 85 includes a first channel 205 and a second channel 157 that cooperate with one another to define a V-shaped channel 210. In the illustrated construction, the first channel 205 is substantially rectangular or linear and defines a substantially linearly extending leg and the second channel 157 is arcuate and defines a substantially arcuate leg. The second channel 157 is arranged such that it curves around a center 215 that resides on or near the pivot axis 60 of the first handle 15 and the second handle 20. When the handles 15, 20 are in the closed position, the first channel 205 substantially overlies the channel 140 formed in the first head portion 30. Thus, the slider 145 and the pin 150 are free to move along the entire length of the first channel 205. When the pin 150 is moved toward the cutting blade 105 as illustrated in FIG. 6, it moves out of the space defined by the second channel 157 such that the walls that define the first channel 205 inhibit movement of the pin 150 around the pivot axis 60. If the pin 150 cannot move around the pivot axis 60, the handles 15, 20 cannot pivot about each other and the device is fixed in the locked position. When the user moves the slider 145 away from the cutting blade 105 and into the second channel 157, the pin 150 becomes free to move about the pivot axis 60, thereby freeing the handles 15, 20 for movement to the open position.

In the locked position, the first handle 15 and second handle 20 are held proximate to each other, as seen in FIG. 1, and the slider 145 inhibits the first handle 15 and second handle 20 from moving relative to one another. In the locked position, the cutter is in the slitting position so that the slitting portion 130 is disposed as seen in FIG. 1 so that a user may slice a tube as has been described.

Although the invention has been described in detail with reference to certain preferred embodiments, variations and modifications exist within the scope and spirit of one or more independent aspects of the invention as described.

Thus, the invention provides, among other things, a tube cutter. Various features and advantages of the invention are set forth in the following claims.

What is claimed is:

1. A cutting tool adapted to cutting a tube, the cutting tool comprising:
a first grip portion;
a second grip portion;
a first head portion coupled to the first grip portion to define a first handle, the first head portion including a cutting blade having a cutting portion and a slitting portion;
a second head portion coupled to the second grip portion to define a second handle, the second head portion including an arcuate portion sized and configured to support the tube and a concave portion sized to receive a portion of the tube, the first handle pivotally coupled to the second handle to move between an open position and a closed position, wherein the cutting portion is operable to cut the tube as the handles move from the open position and the closed position, and wherein the slitting portion is operable to slice the tube supported in the concave portion when the handles are in the closed position.

2. The cutting tool of claim 1, wherein the first grip portion and the first head portion are formed simultaneously as a single piece.

3. The cutting tool of claim 1, further comprising a soft grip member coupled to the first grip portion.

4. The cutting tool of claim 1, wherein the blade includes an edge that defines a first corner and a second corner, and wherein the edge defines the cutting portion and the first corner defines the slitting portion.

5. The cutting tool of claim 4, wherein the edge is V-shaped and defines a point disposed between the first corner and the second corner.

6. The cutting tool of claim 1, wherein the second head portion includes a slot that extends from the arcuate portion to the concave portion such that when the handles are in the closed position, the slitting portion extends through the slot and into the concave portion.

7. The cutting tool of claim 1, further comprising a biasing member operable to bias the first handle and the second handle toward the open position.

8. The cutting tool of claim 1, further comprising a locking mechanism movable between a locked position wherein movement of the first handle with respect to the second handle is inhibited and an unlocked position wherein the first handle is freely movable with respect to the second handle.

9. A cutting tool adapted to cutting a tube, the tool comprising:
a first grip portion;
a second grip portion;
a first head portion coupled to the first grip portion to define a first handle, the first head portion including a first channel;
a second head portion coupled to the second grip portion to define a second handle, the second head portion including a second channel and a third channel, the first handle pivotally coupled to the second handle to move between an open position and a closed position;
a pin connected to the first handle and the second handle to define a pivot access about which the first handle and the second handle pivot in a scissors-like motion; and
a locking pin movable between a locked position wherein the locking pin is positioned within the first channel and the second channel and an unlocked position wherein the locking pin is positioned within the first channel and the third channel.

10. The cutting tool of claim 9, further comprising a slider coupled to the locking pin, the slider movable along the first channel between a locked position and an unlocked position.

11. The cutting tool of claim 9, further comprising a spring plate fixedly attached to the pin and operable to bias the pin into one of the locked position and the unlocked position.

12. The cutting tool of claim 11, wherein the first head portion includes an indentation sized to receive a portion of the spring plate to bias the pin into the locked position.

13. The cutting tool of claim 11, wherein the spring plate includes a leg portion that extends from the pin in a cantilever fashion, and wherein a protrusion is formed on the leg portion, the protrusion cooperating with a slider to inhibit movement of the pin out of the first channel.

14. The cutting tool of claim 9, wherein the first channel and the second channel substantially overlie one another when the first handle and the second handle are in the closed position.

15. The cutting tool of claim 9, wherein the third channel includes an arcuate portion having a center that is substantially on the pivot axis such that the pin is free to move around the pivot axis when the first handle and the second handle move between the closed position and the open position.

16. The cutting tool of claim 9, wherein the second channel and the third channel cooperate with one another to define a single V-shaped channel having a substantially linearly extending leg and an arcuate leg.

17. The cutting tool of claim 9, wherein the first head portion includes a blade having a V-shaped cutting portion and a slitting portion.

18. The cutting tool of claim 17, wherein the second head portion includes an arcuate portion sized to receive the tube for cutting and a concave portion sized to receive the tube for slitting.

19. The cutting tool of claim 18, wherein the second head portion includes a slot that extends from the arcuate portion to the concave portion such that when the handles are in the closed position, the slitting portion extends through the slot and into the concave portion.

20. The cutting tool of claim 9, further comprising a biasing member operable to bias the first handle and the second handle toward the open position.
